(19) United States
(12) Patent Application Publication
(10) Pub. No.: US 2026/0221300 A1
(43) Pub. Date: Jul. 30, 2026

(54) NUCLEAR INSTRUMENTATION DEVICE

(71) Applicant: Mitsubishi Electric Corporation, Chiyoda-ku, Tokyo (JP)

(72) Inventors: Ryuki TANAKA, Chiyoda-ku, Tokyo (JP); Makoto SASANO, Chiyoda-ku, Tokyo (JP)

(73) Assignee: Mitsubishi Electric Corporation, Chiyoda-ku, Tokyo (JP)

(21) Appl. No.: 19/144,058

(22) PCT Filed: Jan. 12, 2023
(86) PCT No.: PCT/JP2023/000536

§ 371 Date: Jun. 27, 2025

(51) Int. Cl. G21C 17/108; G01T 1/17; G21D 3/00

(52) U.S. Cl. CPC G21C 17/108; G01T 1/17; G21D 3/001

(57) ABSTRACT

A signal processing unit of the nuclear instrumentation device includes: an IV conversion section which includes IV conversion circuits corresponding to respective ranges and converts current inputted from a neutron detector to voltage; an amplification section which amplifies voltage and outputs the amplified voltage as output voltage; a calculation section which determines a range on the basis of the output voltage, calculates a current value from the output voltage, and outputs the current value as a measurement value; a range switching section which includes switches corresponding to the respective ranges and switches the range in accordance with a command from the calculation section; and a charge/discharge section which, at a time of switching the range, performs charge/discharge processing of discharging an electric charge stored in a capacitor corresponding to a switching origin range and charging a capacitor corresponding to a switching destination range.

### TECHNICAL FIELD

The present disclosure relates to a nuclear instrumentation device.

### BACKGROUND ART

In monitoring of a nuclear reactor, a neutron emitted from the nuclear reactor is received by a detector, and a current signal outputted from the detector is measured by a nuclear instrumentation device. The nuclear instrumentation device outputs the current measurement value to a host monitoring control device, and the monitoring control device performs control for output and the like on the basis of the condition of the nuclear reactor. In recent years, while the sizes of nuclear reactors are being reduced, a current value measured by the nuclear instrumentation device can be in μA order or less, and as compared to conventional art, current that is slight and in a high dynamic range is required to be measured with high accuracy.

In order to measure current in a high dynamic range with high accuracy, it is necessary to perform measurement in an optimum range in accordance with the magnitude of a measurement value, but there is a problem that switching the range causes change in the measurement value. Accordingly, there is known a technology in which, in switching of the range to an optimum range after the optimum range is determined, a signal is retained at a certain value during a period that is an integer multiple of a time constant of a circuit (see, for example, Patent Document 1).

### CITATION LIST

### Patent Document

Patent Document 1: Japanese Laid-Open Patent Publication No. 63-11887

### SUMMARY OF THE INVENTION

### Problem to be Solved by the Invention

However, the technology in Patent Document 1 has a problem that accurate measurement might not be performed in a case where change in an input signal which is a measurement target occurs in a short time. Specifically, in a case where change in an input signal occurs in a shorter time than the time constant of the circuit, change during a period in which the signal is retained at the certain value cannot be measured.

The present disclosure has been made to solve the above problem, and an object of the present disclosure is to provide a nuclear instrumentation device capable of performing measurement with higher accuracy than in conventional art, for current that is slight and in a high dynamic range.

### Means to Solve the Problem

A nuclear instrumentation device according to the present disclosure is a nuclear instrumentation device having a plurality of ranges including a first range and a second range, the nuclear instrumentation device including: a current-voltage conversion section which includes current-voltage conversion circuits which each have a capacitor and a resistor connected in parallel and correspond to the respective ranges, and converts current inputted from a neutron detector to voltage; an amplification section which amplifies the voltage and outputs the amplified voltage as output voltage; a range switching section which includes a switch for turning ON/OFF a current-voltage conversion circuit corresponding to the second range, and switches the range by changing the current-voltage conversion circuit to be turned ON or a combination of the current-voltage conversion circuits to be turned ON; a calculation section which determines the range to be used for measurement for the current, as a measurement range, on the basis of the output voltage, and causes the range switching section to switch the range to the measurement range, and which calculates a current value of the current from the output voltage and outputs an obtained result; and a charge/discharge section which, at a time of switching the range, performs charge/discharge processing of discharging an electric charge stored in the capacitor corresponding to the range before the switching, and charging the capacitor corresponding to the range after the switching, with the electric charge.

### Effect of the Invention

The nuclear instrumentation device according to the present disclosure is capable of performing measurement with higher accuracy than in conventional art, for current that is slight and in a high dynamic range,

### BRIEF DESCRIPTION OF THE DRAWINGS

FIG. 1 is a schematic diagram illustrating monitoring control for a nuclear reactor according to embodiment 1.

FIG. 2 schematically shows a reactor core and detector assemblies attached at the inside and the outside of the reactor core, according to embodiment 1.

FIG. 3 shows a configuration of an in-reactor fixed detector assembly according to embodiment 1.

FIG. 4 illustrates detection for a neutron.

FIG. 5 is a configuration diagram schematically showing a signal processing unit of a nuclear instrumentation device according to embodiment 1.

FIG. 6 is a configuration diagram showing the signal processing unit according to embodiment 1 and illustrating the detailed configuration of a charge/discharge section according to embodiment 1.

FIG. 7 is a block diagram showing a calculation section according to embodiment 1.

FIG. 8 shows an example of a hardware configuration of the calculation section according to embodiment 1.

FIG. 9 is a flowchart showing operation of the signal processing unit of the nuclear instrumentation device according to embodiment 1,

FIG. 10 is a flowchart showing a range switching process according to embodiment 1.

FIG. 11A illustrates the range switching process according to embodiment 1 and shows a state in which the range is set at a range 1.

FIG. 11B illustrates the range switching process according to embodiment 1 and shows a state in which switches of a circuit for a range 2 are turned on,

FIG. 11C illustrates the range switching process according to embodiment 1 and shows a state in which switches of a circuit for the range 1 are turned off.

FIG. 11D illustrates the range switching process according to embodiment 1 and shows a state in which charging is being performed by the charge/discharge section.

FIG. 11E illustrates the range switching process according to embodiment 1 and shows a state in which charging is completed by the charge/discharge section.

FIG. 12A shows difference in output voltage of an amplifier at the time of range switching, between a case of performing charging/discharging by the charge/discharge section and a case of not performing the charging/discharging,

FIG. 12B shows difference in a measurement value at the time of range switching, among case of performing charging/discharging by the charge/discharge section, a case of not performing the charging/discharging, and conventional art.

FIG. 13 is a flowchart showing another example of the range switching process according to embodiment 1.

FIG. 14 is a configuration diagram showing a first modification of the signal processing unit according to embodiment 1.

FIG. 15 is a configuration diagram showing a second modification of the signal processing unit according to embodiment 1.

FIG. 16 is a configuration diagram showing a signal processing unit according to embodiment 2,

FIG. 17 shows a charge amount table for compensation capacitors according to embodiment 2.

FIG. 18 is a flowchart showing a range switching process according to embodiment 2.

FIG. 19 is a configuration diagram showing a learning section according to embodiment 3.

FIG. 20 is a configuration diagram showing an inference section according to embodiment 3.

FIG. 21 is a flowchart showing operation of a signal processing unit of a nuclear instrumentation device according to embodiment 3.

### DESCRIPTION OF EMBODIMENTS

### Embodiment 1

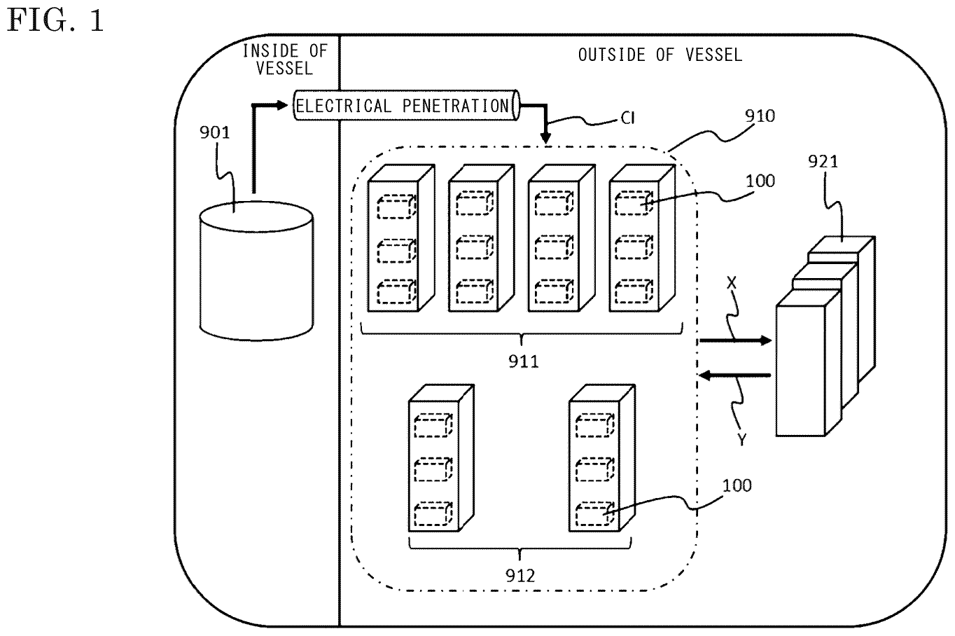

Embodiment 1 will be described with reference to FIG. 1 to FIG. 13. FIG. 1 is a schematic diagram illustrating monitoring control for a nuclear reactor according to embodiment 1. A monitoring control device 921 performs monitoring control for the condition in a reactor vessel, and acquires information such as a dose rate of a neutron emitted by a reactor core 901 placed in the reactor vessel, to recognize the condition in the reactor vessel. The dose rate of a neutron is calculated on the basis of a current value of a current signal CI outputted through detection for a neutron by various neutron detectors (not shown in FIG. 1) provided in the reactor vessel. The current signal CI outputted by the neutron detector is transmitted to the outside of the reactor vessel via an electrical penetration extending between the inside and the outside of the reactor vessel, and a current value is measured by a nuclear instrumentation device 910 outside the reactor vessel. The current value measured by the nuclear instrumentation device 910 is transmitted as a measurement value X to the monitoring control device 921 via a host interface (not shown). A control command Y from the monitoring control device 921 to the nuclear instrumentation device 910 is also transmitted via the host interface.

The nuclear instrumentation device 910 includes an out-of-reactor nuclear instrumentation device 911 and an in-reactor nuclear instrumentation device 912 which respectively correspond to different neutron detectors and each have one or a plurality of signal processing units 100 therein. The signal processing unit 100 receives the current signal CI and outputs the measurement value X. The details of the signal processing unit 100 will be described later.

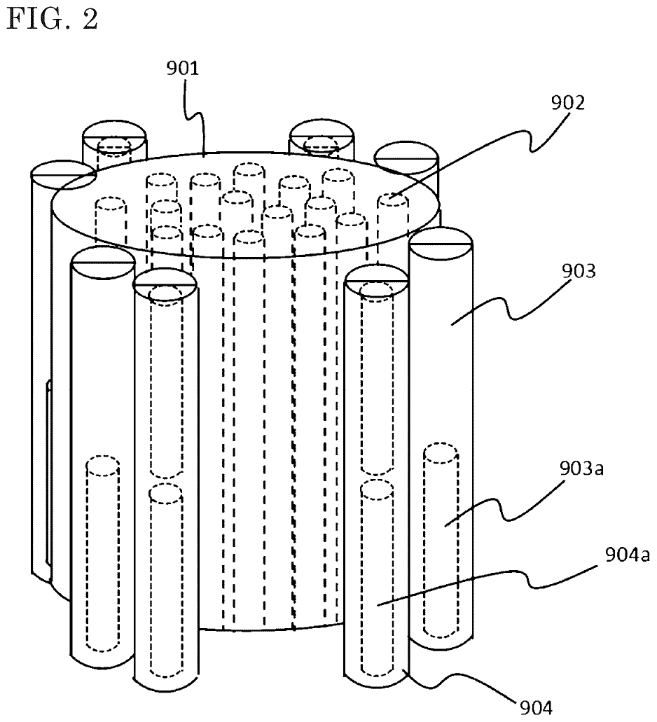

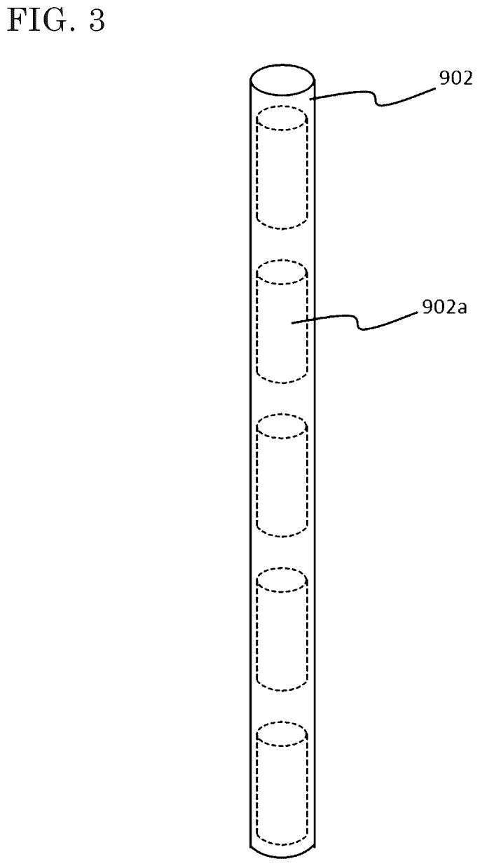

FIG. 2 schematically shows the reactor core and detector assemblies attached at the inside and the outside of the reactor core according to embodiment 1, and FIG. 3 shows a configuration of an in-reactor fixed detector assembly according to embodiment 1. An in-reactor fixed detector assembly 902 is fixed inside the reactor core 901, and a radiation-source-area detector assembly 903 and a wide-area detector assembly 904 are fixed at the outer circumference of the reactor core 901. As shown in FIG. 3, for example, five neutron detectors 902a are arranged in series inside the in-reactor fixed detector assembly 902. The radiation-source-area detector assembly 903 and the wide-area detector assembly 904 also have a neutron detector 903a and a neutron detector 904a therein in the same manner, respectively.

The neutron detector 902a of the in-reactor fixed detector assembly 902 corresponds to the in-reactor nuclear instrumentation device 912, and the neutron detector 903a of the radiation-source-area detector assembly 903 and the neutron detector 904a of the wide-area detector assembly 904 correspond to the out-of-reactor nuclear instrumentation device 911.

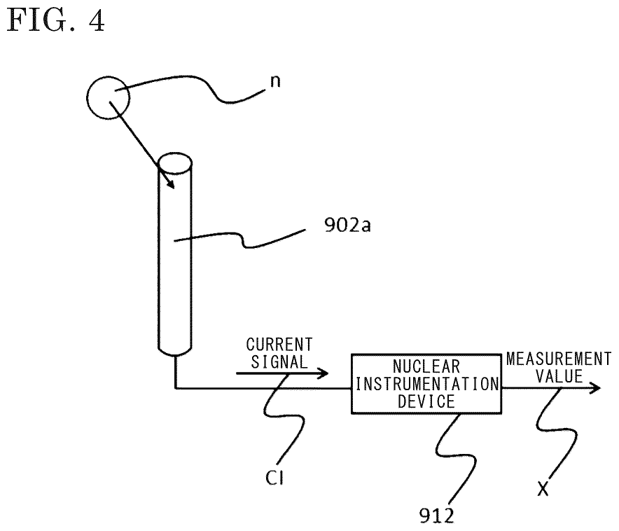

FIG. 4 illustrates detection for a neutron. In FIG. 4, the neutron detector 902a is shown, but the same applies to detection for a neutron by the neutron detector 903a and the neutron detector 904a. When a neutron n emitted from the reactor core 901 is received by the neutron detector 902a, an electron in a material forming the neutron detector 902a is ejected, so that current flows. The current is transmitted as the current signal CI to the in-reactor nuclear instrumentation device 912 (in FIG. 4, referred to as nuclear instrumentation device; in a case of the neutron detector 903a or the neutron detector 904a, the current signal CI is transmitted to the out-of-reactor nuclear instrumentation device 911). The in-reactor nuclear instrumentation device 912 that has received the current signal CI measures a current value of the current signal CI and outputs the current value as the measurement value X.

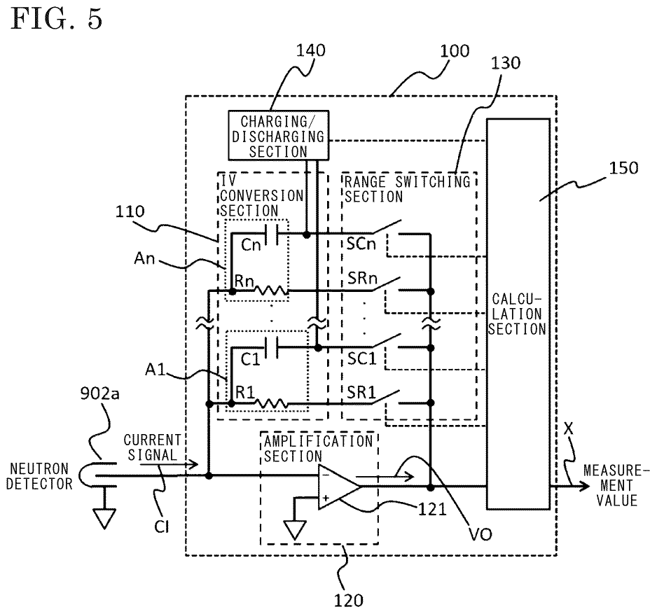

Measurement for the current value of the current signal CI is implemented by the signal processing units 100 provided in the out-of-reactor nuclear instrumentation device 911 and the in-reactor nuclear instrumentation device 912. FIG. 5 is a configuration diagram schematically showing the signal processing unit of the nuclear instrumentation device according to embodiment 1. The signal processing unit 100 measures the current value of the current signal CI with a range determined to be optimum in accordance with the current signal CI inputted via an input terminal (not shown), and performs current-voltage conversion (hereinafter, referred to as IV conversion). That is, the signal processing unit 100 includes: an IV conversion section 110 (corresponding to “current-voltage conversion section”) which converts the current signal CI to a voltage signal; an amplification section 120 which amplifies the voltage converted by the IV conversion section 110 with a gain according to the range and outputs output voltage VO; a range switching section 130 which is connected in series to the IV conversion section 110 and switches the range for measurement; a charge/discharge section 140 which is connected to the IV conversion section 110 and performs charge/discharge processing for capacitors at the time of switching the range; and a calculation section 150 which receives the output voltage VO, calculates the measurement value X from the output voltage VO, outputs the measurement value X, and performs a range switching command for the range switching section 130 and a charge/discharge command for the charge/discharge section 140.

The IV conversion section 110 is configured such that IV conversion circuits (corresponding to “current-voltage conversion circuits”) respectively corresponding to ranges 1 to n (n is an integer not less than 2) are connected in parallel. In the IV conversion circuit for each range, a resistor and a capacitor connected in parallel to each other are provided. Hereinafter, the resistors and the capacitors corresponding to the respective ranges are referred to as a resistor R1, a resistor R2, . . . a resistor Rn, and a capacitor C1, a capacitor C2, . . . , a capacitor Cn. In FIG. 5, an IV conversion circuit A1 is an IV conversion circuit corresponding to the range 1, and the IV conversion circuit An is an IV conversion circuit corresponding to the range n. The IV conversion circuits for the ranges 2 to (n−1) are not shown. The resistances of the resistor R1, the resistor R2, . . . , the resistor Rn are also referred to as R1, R2, . . . , Rn, respectively, and the capacitances of the capacitor C1, the capacitor C2, . . . , the capacitor Cn are also referred to as C1, C2, . . . , Cn, respectively. In embodiment 1, when the current value which is a measurement target is greater, a higher range is used, and when the range is smaller, the resistance of the corresponding resistor is greater.

In the description, the input terminal side of the signal processing unit 100 (left side in FIG. 5) is defined as an input side and the side opposite to the input side is defined as an output side. Since a non-inverting input terminal of an amplifier 121 is connected to a ground potential, the input side of the IV conversion section 110 is virtually grounded.

In embodiment 1, the constants of the circuits are set such that products of resistances and capacitances for the respective ranges are equal to each other. That is, in embodiment 1, the following Formula (1) is satisfied,

$$R 1 \times C 1 = R 2 \times C 2 = … = Rn \times Cn \qquad ( 1 )$$

Since the Formula (1) is satisfied, the time constants of the IV conversion circuits for the respective ranges are equal to each other.

The amplification section 120 has the amplifier 121. An inverting input terminal of the amplifier 121 is connected to the input terminal of the signal processing unit 100 and the input side of the IV conversion section 110 (the input side of the IV conversion circuit for each range). The non-inverting input terminal of the amplifier 121 is connected to the ground potential. An output terminal of the amplifier 121 is connected to the calculation section 150. The output terminal of the amplifier 121 is connected to the inverting input terminal of the amplifier 121 via the range switching section 130 and the IV conversion section 110. Specifically, a feedback circuit is formed by switches of the range switching section 130 and the IV conversion circuit of the IV conversion section 110 corresponding to each range.

The range switching section 130 is configured such that switches corresponding to the IV conversion circuits for the respective ranges are connected in parallel. The input side of the range switching section 130 is connected to the output side of the IV conversion section 110. The output side of the range switching section 130 is connected to the output terminal of the amplifier 121 and the calculation section 150.

As described above, in the IV conversion circuit for each range, the resistor and the capacitor connected in parallel to each other are provided. Also in the range switching section 130, switches respectively corresponding to the resistors and the capacitors are provided in parallel. In FIG. 5, the switches corresponding to the resistors (resistor R1, resistor R2, . . . , resistor Rn) for the respective ranges are referred to as a switch SR1, a switch SR2, . . . , a switch SRn. The input sides of the switch SR1, the switch, the switch SRn are connected to the output sides of the resistor R1, the resistor R2, . . . , the resistor Rn. The switches corresponding to the capacitors (capacitor C1, capacitor C2, . . . , capacitor Cn) for the respective ranges are referred to as a switch SC1, a switch SC2, . . . , a switch SCn. The input sides of the switch SC1, the switch SC2, . . . , the switch SCn are connected to the output sides of the capacitor C1, the capacitor C2, . . . , the capacitor Cn.

The output sides of the switch SR1, the switch SR2, . . . , the switch SRn, and the switch SC1, the switch SC2, . . . , the switch SCn, are connected to the output terminal of the amplifier 121 and the input side of the calculation section 150. ON/OFF operations of the switch SR1, the switch SR2, . . . , the switch SRn, and the switch SC1, the switch SC2, . . . , the switch SCn, are controlled by the calculation section 150.

The charge/discharge section 140 is connected to the output sides of the capacitors (capacitor C1, capacitor C2, . . . , capacitor Cn) for the respective ranges in the IV conversion section 110. Operation of the charge/discharge section 140 is controlled by the calculation section 150.

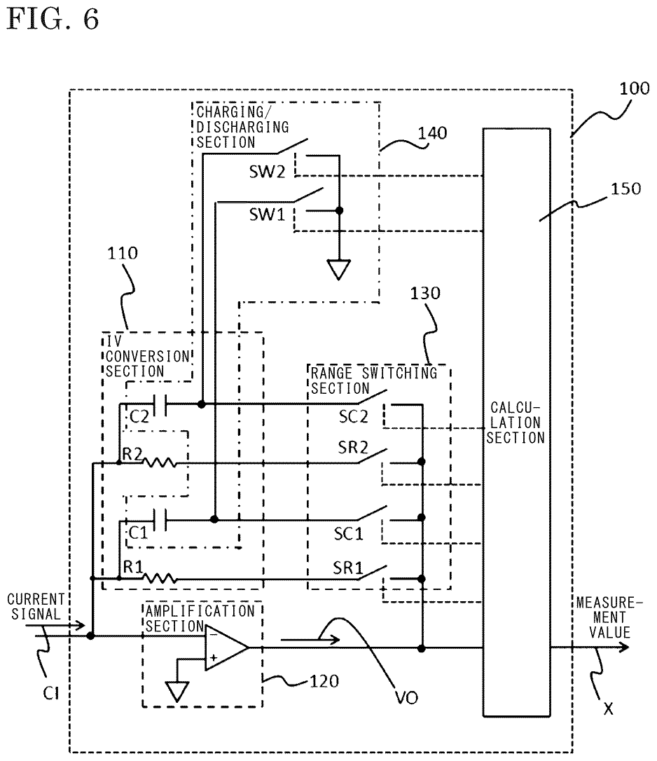

The details of the charge/discharge section 140 will be described. Here, for simplification of description, only the range 1 and the range 2 are shown as the ranges, but the same applies to a case of having the range 3 and subsequent ranges. FIG. 6 is a configuration diagram showing the signal processing unit according to embodiment 1 and illustrates the detailed configuration of the charge/discharge section according to embodiment 1. As described above, in embodiment 1, the constants of the circuits are set such that products of the resistances and the capacitances for the respective ranges in the IV conversion section 110 are equal to each other. When this condition is satisfied, the capacitors for the respective ranges in the IV conversion section 110 serve also as a part of the charge/discharge section 140. In this case, the charge/discharge section 140 can be realized by a simple combination of switches. In the charge/discharge section 140, the switch SW1 and the switch SW2 connected in parallel are provided. The input side of the switch SW1 is connected to the output side of the capacitor C1, i.e., between the capacitor C1 and the switch SC1. The input side of the switch SW2 is connected to the output side of the capacitor C2, i.e., between the capacitor C2 and the switch SC2. The output sides of the switch SW1 and the switch SW2 are connected to a ground potential. The switch SW1 and the switch SW2 correspond to second switches.

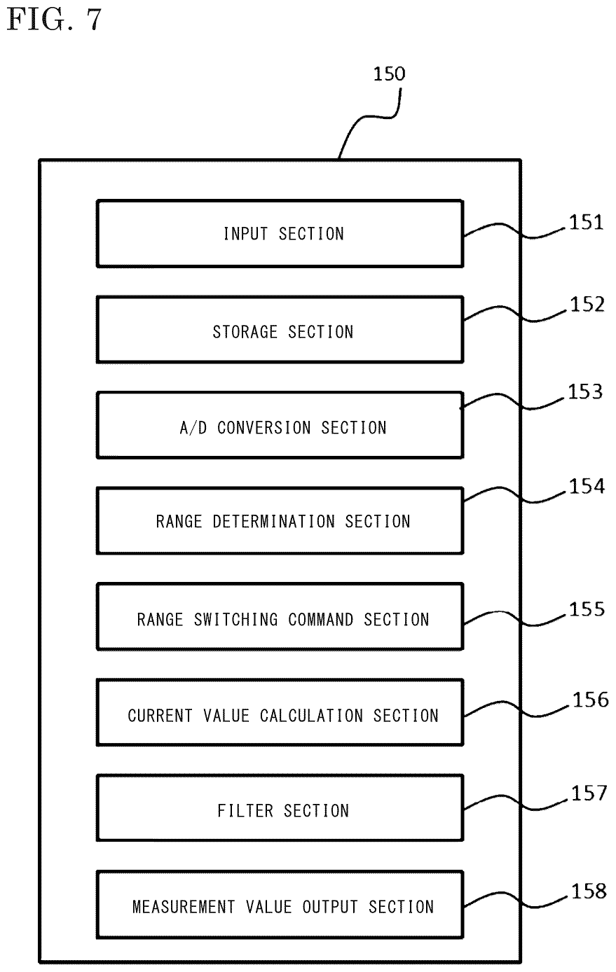

Next, the calculation section 150 will be described. FIG. 7 is a block diagram showing the calculation section according to embodiment 1. The calculation section 150 performs various calculations, determination of a range to be used for measurement, i.e., a measurement range, and control for various switches, in the signal processing unit 100. As shown in FIG. 7, the calculation section 150 includes: an input section 151 which receives an input of output voltage VO of the amplifier 121 and the like; a storage section 152 which stores data of a threshold to be used for determination of the measurement range, data of a calculation formula for calculating the current value from the output voltage VO, and the like; an A/D conversion section 153 which performs A/D conversion (analog-digital conversion) of the output voltage VO; a range determination section 154 which determines a range optimum for measurement as the measurement range on the basis of the value of the output voltage VO converted to a digital value; a range switching command section 155 which, when the present range is different from the measurement range, outputs a command to the range switching section 130 so that the range becomes the measurement range, and outputs a command for charge/discharge processing accompanying switching of the range, to the charge/discharge section; a current value calculation section 156 which calculates a current value by a calculation formula set for each range from the value of the output voltage VO converted to a digital value and generates a current signal; a filter section 157 which filters the current signal generated by the current value calculation section 156, to remove noise; and a measurement value output section 158 which outputs the current value of the current signal from which noise has been removed, as the measurement value X,

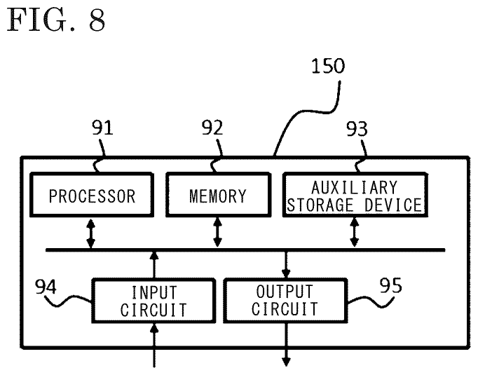

FIG. 8 shows an example of a hardware configuration of the calculation section according to embodiment 1. The calculation section 150 is mainly composed of a processor 91, a memory 92 as a primary storage, and an auxiliary storage device 93. The processor 91 is formed by a central processing unit (CPU), an application specific integrated circuit (ASIC), a digital signal processor (DSP), a field programmable gate array (FPGA), and the like, for example. The memory 92 is formed by a volatile storage device such as a random access memory, and the auxiliary storage device 93 is formed by a nonvolatile storage device such as a flash memory, a hard disk, or the like. The auxiliary storage device 93 stores a predetermined program to be executed by the processor 91, and the processor 91 reads and executes the program as appropriate, to perform various calculation processes. At this time, the predetermined program is temporarily stored into the memory 92 from the auxiliary storage device 93, and the processor 91 reads the program from the memory 92. Calculation processing by each function section shown in FIG. 1 is implemented by the processor 91 executing the predetermined program as described above. A result of the calculation processing by the processor 91 is stored into the memory 92 once, and then is stored into the auxiliary storage device 93 in accordance with the purpose of the executed calculation processing.

The memory 92 and the auxiliary storage device 93 serve for the storage section 152 to store various data as described above. The calculation section 150 includes an input circuit 94 which receives various inputs to the calculation section 150, and an output circuit 95 which performs output from the calculation section 150.

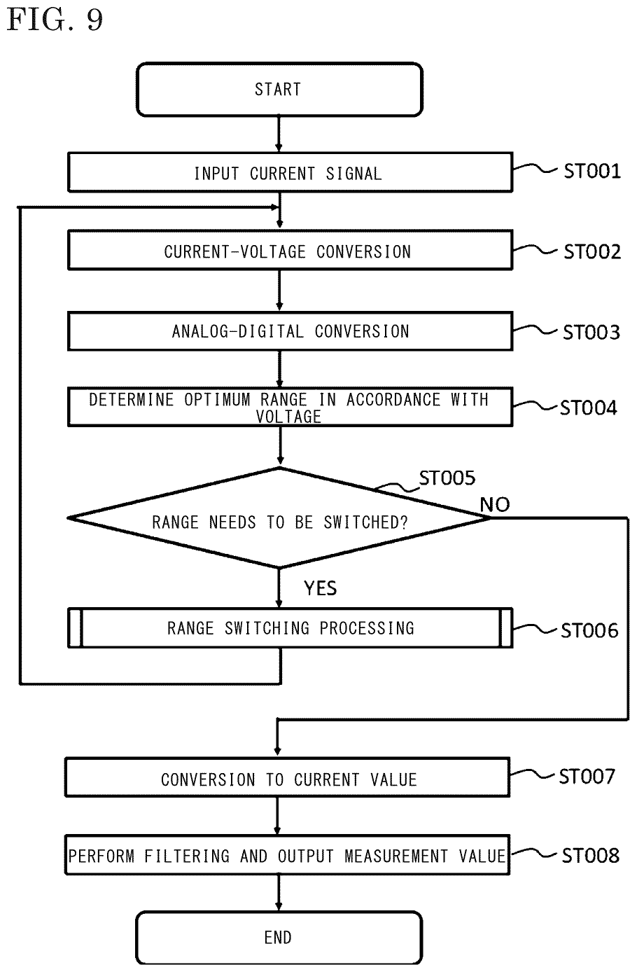

Next, operation will be described. FIG. 9 is a flowchart showing operation of the signal processing unit of the nuclear instrumentation device in embodiment 1. First, the current signal CI from the neutron detector 902a is inputted (step ST001).

Next, the IV conversion section 110 converts the current signal CI to a voltage signal (step ST002). Specifically, the IV conversion circuit for the range turned ON in the IV conversion section 110 converts the current signal CI to a voltage signal. The “IV conversion circuit for the range turned ON” is an IV conversion circuit for which the switches for the corresponding range are set to be ON in the range switching section 130. The voltage signal converted from the current signal CI is controlled by the amplification section 120 so that the virtual grounding is kept, and is outputted as the output voltage VO, which is inputted to the calculation section 150.

Next, the output voltage VO is subjected to analog-digital conversion (step ST003).

Next, an optimum range is determined as the measurement range (step ST004). In addition, the determined measurement range is compared with the present range, to determine whether or not the range needs to be switched (step ST005). If the range need not be switched, it is determined that the present range has been set at the optimum range, and the process proceeds to step ST007.

If the range needs to be switched, the range switching process is performed (step ST006), and after the range is switched, the process returns to step ST002. The details of the range switching process will be described later.

If it is determined that the present range has been set at the optimum range, a current value is calculated from the output voltage VO (step ST007). Next, a current signal generated as a result of calculation of the current value is filtered and an obtained measurement value X is outputted (step ST008).

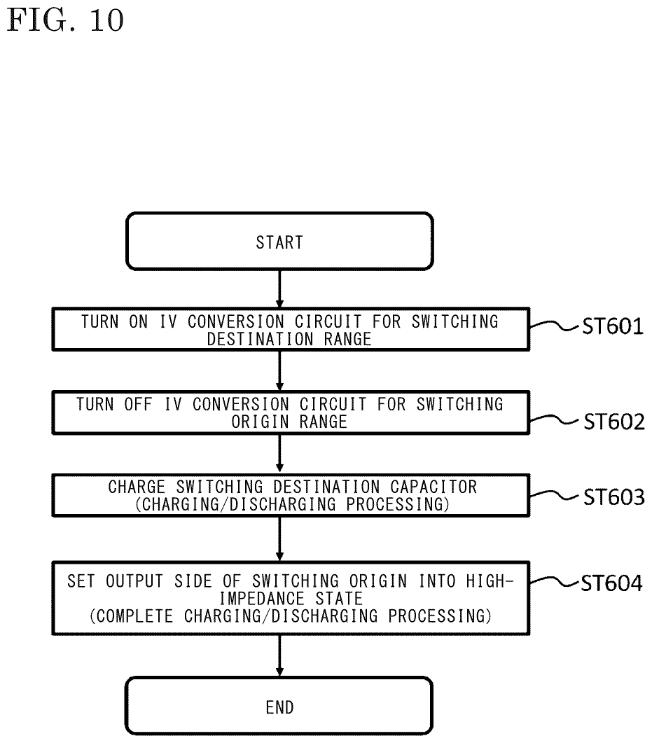

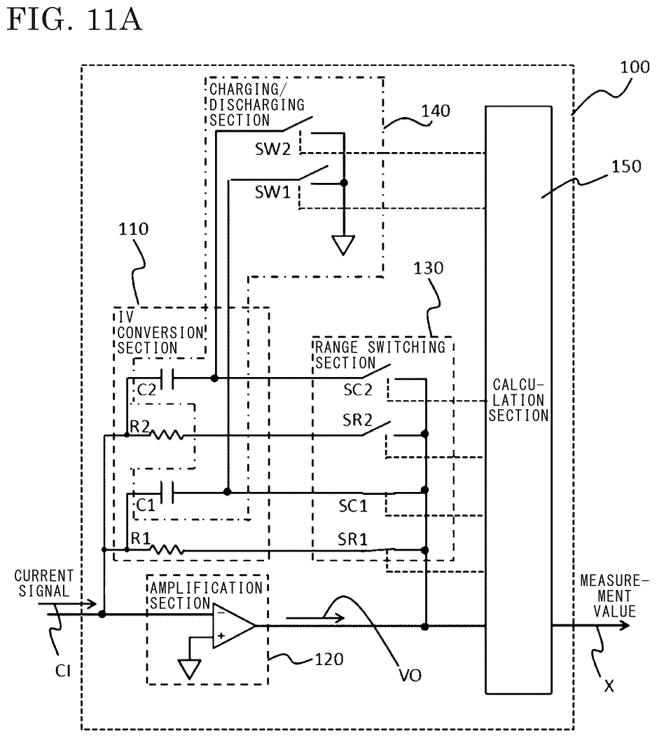

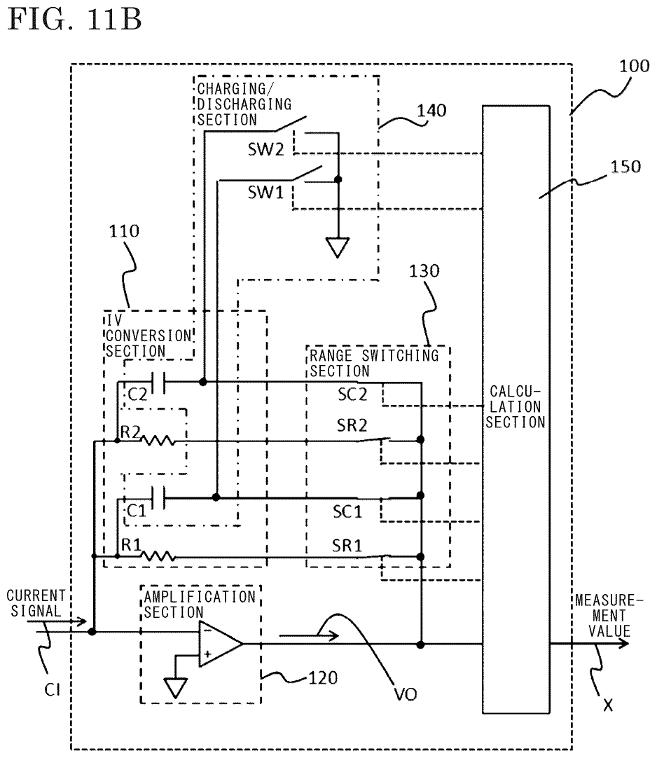

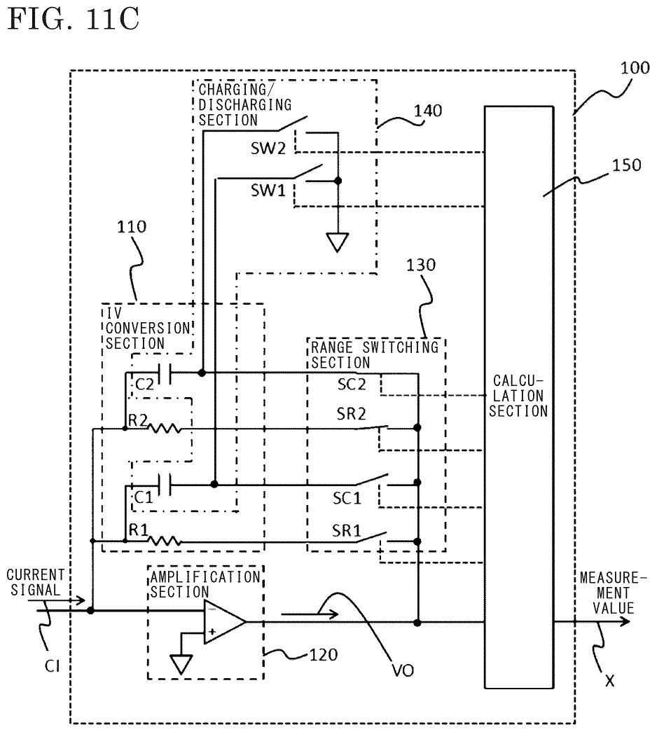

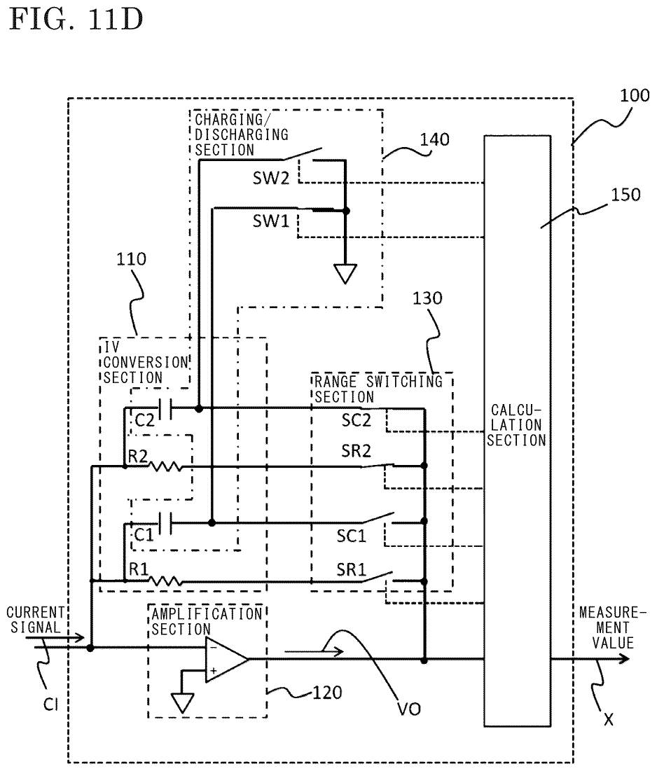

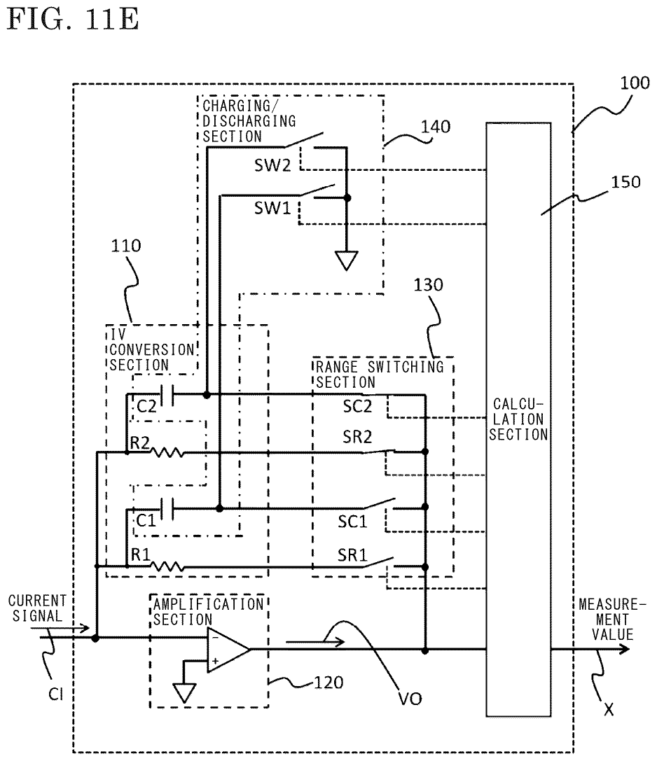

The range switching process will be described. FIG. 10 is a flowchart showing the range switching process according to embodiment 1. As described above, the signal processing unit 100 measures a current value with the measurement range determined in accordance with the output voltage VO of the amplifier 121, and the range to be used for measurement is switched to the above measurement range, as appropriate. Here, several methods are conceivable for setting the range at a specific measurement range. For example, only one IV conversion circuit may be turned ON to realize the measurement range, or a plurality of IV conversion circuits to be turned ON may be combined to realize the measurement range. In either method, a calculation formula for calculating a current value from the output voltage VO may be set in accordance with constants of the IV conversion circuit (or a combination of circuits) to be turned ON. First, a case of using the method of turning ON only one IV conversion circuit will be described. In this method, the range before switching is defined as a switching origin range, the range after switching is defined as a switching destination range, and connection of the IV conversion circuit corresponding to the switching origin range is switched to connection of the IV conversion circuit corresponding to the switching destination range. Here, it is assumed that the switching origin range is the range 1 and the switching destination range is the range 2, and description will be given with reference to FIG. 11A to FIG. 11E.

In the initial state, the set range is the range 1, and therefore, as shown in FIG. 11A, the switch SC1 and the switch SR1 corresponding to the IV conversion circuit for the range 1 are ON and the switch SC2 and the switch SR2 corresponding to the IV conversion circuit for the range 2 are OFF. The switch SW1 and the switch SW2 of the charge/discharge section 140 are also OFF.

In the range switching process, first, the IV conversion circuit for the switching destination range is turned ON (step ST601). As shown in FIG. 11B, the switch SC2 and the switch SR2 corresponding to the IV conversion circuit for the range 2 are turned ON, so that both of the IV conversion circuit for the range 1 and the IV conversion circuit for the range 2 are ON.

Next, the IV conversion circuit for the switching origin range is turned OFF (step ST602). As shown in FIG. 11C, the switch SC1 and the switch SR1 corresponding to the IV conversion circuit for the range 1 are turned OFF. Thus, only the IV conversion circuit for the range 2 becomes ON.

Next, discharging from the capacitor for the switching origin range to the capacitor for the switching destination range is performed (step ST603, charge/discharge processing). As shown in FIG. 11D, in the charge/discharge section 140, the switch SW1 corresponding to the switching origin range (range 1) is turned ON. Thus, a route on which current flows from the ground of the charge/discharge section 140 through the switch SW1, the capacitor C1, the capacitor C2, and the output terminal of the amplifier 121 to the ground potential of the amplification section 120, is formed, so that an electric charge stored in the capacitor C1 is discharged from the capacitor C1 to the capacitor C2, thus charging the capacitor C2. In addition, as described above, in embodiment 1, the time constants of the IV conversion circuits for the respective ranges are equal to each other, and therefore the capacitor C2 is charged without excess/deficiency through discharging from the capacitor C1 to the capacitor C2.

Next, the output side of the capacitor for the switching origin range is set to have a high impedance, to complete the charge/discharge processing (step ST604). As shown in FIG. 11E, the switch SW1 corresponding to the range 1 is turned OFF. Since the switch SW1 is connected to the output side of the capacitor C1, the output side of the capacitor C1 corresponding to the range 1 which is the switching origin range is set to have a high impedance. Thus, the charge/discharge processing is completed. In addition, the range switching process is also completed, and thereafter, measurement with the range 2 is performed.

Here, since switching from the range 1 to the range 2 has been described, charge/discharge processing has been performed by operating the switch SW1. In a case of switching from the range 2 to the range 1, the range 2 is the switching origin range and therefore charge/discharge processing is performed by operating the switch SW2. That is, in charge/discharge processing, among the switches in the charge/discharge section 140, the switches corresponding to the range for which the IV conversion circuit is to be turned OFF along with range switching are operated, whereby charge/discharge processing and completion thereof are performed.

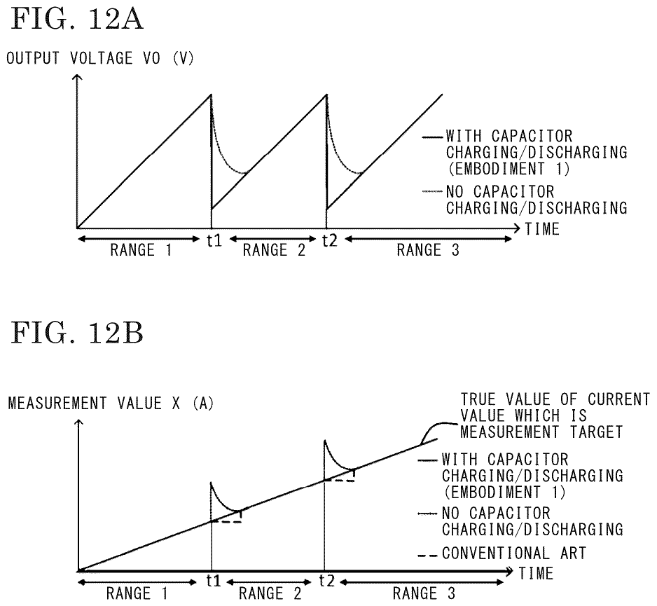

Next, effects of embodiment 1 will be described. FIG. 12A shows difference in output voltage of the amplifier at the time of range switching, between a case of performing charging/discharging by the charge/discharge section and a case of not performing the charging/discharging, and FIG. 12B shows difference in the measurement value at the time of range switching, among a case of performing charging/discharging by the charge/discharge section, a case of not performing the charging/discharging, and conventional art. In FIG. 12A and FIG. 12B, the horizontal axis indicates time, and range switching is performed at times t1 and t2. FIG. 12A and FIG. 12B show a situation in which the current value which is a measurement target gradually increases and the range is also gradually becoming higher.

As shown in FIG. 12A, in the case of not performing charge/discharge processing (dotted line), decrease in the output voltage VO of the amplification section 120 at the time of range switching is delayed, Specifically, in the case of not performing charge/discharge processing, convergence of the output voltage VO at the time of range switching takes time corresponding to the time constant determined by a charging period of the capacitor. Here, the “charging period of the capacitor” is a charging period of the capacitor for the switching destination range, and is determined by a “product of the resistance of the resistor for the switching destination range and the capacitance of the capacitor for the switching destination range”. As shown in Formula (1), the above product is also a product of the resistance of the resistor for the switching origin range and the capacitance of the capacitor for the switching origin range. In the case of performing charge/discharge processing (solid line), the output voltage VO sharply decreases. To be strict, even in the case of performing charge/discharge processing, convergence of the output voltage VO takes time, but the “charging period of the capacitor” which determines the convergence period is a “product of the output impedance of the charge/discharge section and the capacitance of the capacitor for the switching destination range”, and therefore a convergence period of the output voltage VO can be shortened.

As shown in FIG. 12B, the same applies to the measurement value X. That is, at the time of range switching, the measurement value X temporarily rises, and then convergence takes time in the case of not performing charge/discharge processing (dotted line) but convergence can be completed in a short time in the case of performing charge/discharge processing (solid line). In FIG. 12B, the case where the measurement value X increases is shown and therefore the measurement value X rises at the time of range switching, but in a case where the measurement value X decreases, the measurement value X falls at the time of range switching. In any case, the effects of embodiment 1 are not influenced.

Rising of the measurement value X shown in FIG. 12B represents shift from a true value at the time of range switching, and accuracy of measurement is higher when the magnitude of shift and the time during which the shift is occurring are smaller. In FIG. 12B, a case of conventional art (technology described in Patent Document 1) is also indicated by a dotted line, and it is found that, at the time of range switching, temporary shift from a true value occurs also in conventional art. In embodiment 1, by the charge/discharge processing at the time of range switching, measurement accuracy is improved at the time of range switching and therefore in the entire measurement. In order to enhance measurement accuracy, it is general that the time constant of the circuit is set to be great, but as described above, in the case where the time constant of the circuit is great, there is a problem that convergence of the output voltage VO and the measurement value X at the time of range switching takes time. That is, when the time constant of the circuit is merely set to be great, it is difficult to perform high-accuracy measurement for current that is slight and in a high dynamic range.

In embodiment 1, with the configuration in which charge/discharge processing is performed at the time of range switching, the convergence period of the measurement value X at the time of range switching is caused to depend on the output impedance of the charge/discharge section. Thus, while the time constants of the IV conversion circuits for the respective ranges are increased, the convergence period of the measurement value X at the time of range switching can be shortened, whereby it becomes possible to perform high-accuracy measurement for current that is slight and in a high dynamic range.

In embodiment 1, the above Formula (1) is satisfied. When Formula (1) is satisfied, charging/discharging without excess/deficiency is performed between the capacitor for the switching origin range and the capacitor for the switching destination range, whereby effects can be ideally obtained. However, even if Formula (1) is not satisfied, discharging from the capacitor for the switching origin range to the capacitor for the switching destination range is performed, and thus the same effects can be obtained, though being limited.

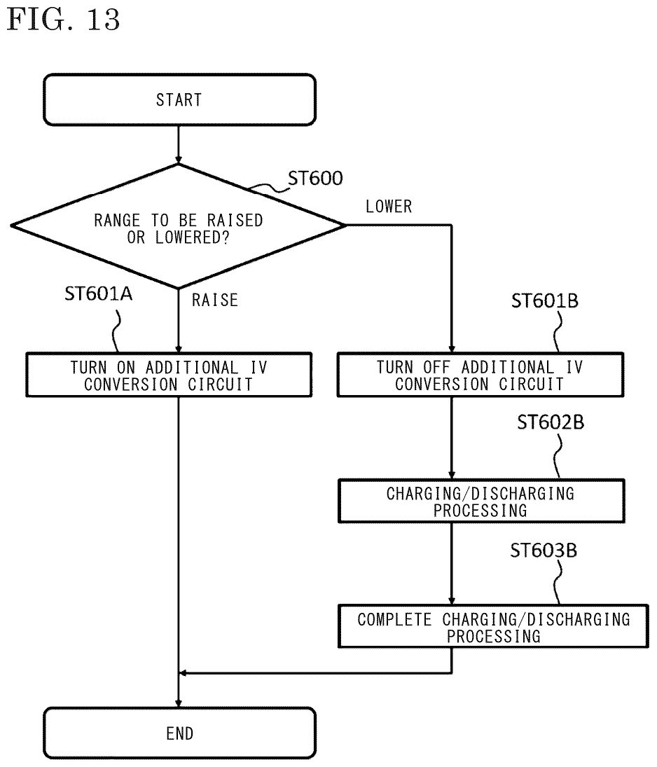

Next, another example of the range switching process according to embodiment 1 will be described with reference to FIG. 13. In this example, a plurality of IV conversion circuits to be turned ON are combined to realize the measurement range. Specifically, only the IV conversion circuit for the range 1 is turned ON to realize measurement with the range 1, and the IV conversion circuits for the range 1 and the range 2 are turned ON to realize measurement with the range 2. The “range 2” in the example in FIG. 10 and FIG. 11A to FIG. 11E is different from the “range 2” in the example in FIG. 13, but as described above, a formula to be used for calculating a current value in the calculation section 150 is set to be an optimum one and therefore the same result can be obtained. For example, in a case where the calculation formula is a linear expression, the coefficient of the linear term and the constant term may be set at values according to the range. In addition, these values are determined by the constants (resistance and capacitance) of the IV conversion circuit corresponding to each range. As described later, in the example in FIG. 13, the IV conversion circuit for the range 1 is always ON and the range is switched in accordance with whether or not to additionally turn ON the IV conversion circuits for the range 2 and the subsequent ranges. Matters other than the range switching process are the same as in FIG. 9, and therefore only the range switching process will be described,

First, whether or not to raise or lower the range is determined (step ST600). If the range is raised, an additional IV conversion circuit (in a case of raising from the range 1 to the range 2, the IV conversion circuit for the range 2) is turned ON (step ST601A). That is, the switch SC2 corresponding to the capacitor C2 and the switch SR2 corresponding to the resistor R2 are turned ON. If the range is lowered, the additional IV conversion circuit which has been turned ON (in a case of lowering from the range 2 to the range 1, the IV conversion circuit for the range 2) is turned OFF (step ST601B). That is, the switch SC2 corresponding to the capacitor C2 and the switch SR2 corresponding to the resistor R2 are turned OFF.

In the case of raising the range, the process ends at the time when the additional IV conversion circuit is turned ON. When the switch SC2 and the switch SR2 are turned ON for connection from the range 1 to the range 2, an electric charge charged in the capacitor C1 at this time is partially charged into the capacitor C2 so that electric charges are distributed at a ratio of C1 and C2. Therefore, operation of the switch SW1 for the charge/discharge processing and completion thereof is not needed.

In the case of lowering the range, the IV conversion circuit additionally turned ON is turned OFF and the charge/discharge processing (step ST602B) and completion of the charge/discharge processing (step ST603B) are needed. In the case of lowering the range 2 to the range 1, the switch SC2 and the switch SR2 which have been turned ON are turned OFF and the switch SW2 is turned ON, so that an electric charge in the capacitor C2 is discharged to charge the capacitor C1. Then, the switch SW2 is turned OFF, whereby the output side of the capacitor for the range 2 is set to have a high impedance, thus completing the charge/discharge processing.

As described above, in the case of performing measurement with the range 2 by turning ON the IV conversion circuits for the range 1 and the range 2, the IV conversion circuit for the range 1 is always ON and switch operation for charge/discharge processing is not needed at the time of switching from the range 1 to the range 2. Accordingly, the switch SC1, the switch SR1, and the switch SW1 corresponding to the range 1 can be omitted. This is because the switch SC1 and the switch SR1 are always ON and the switch SW1 is always OFF.

According to the examples in FIG. 10 and FIG. 13, depending on the method for realizing the measurement range, there is a case where the IV conversion circuit for the range 1 is turned ON/OFF and a case where the ON/OFF operation is not needed. On the other hand, the IV conversion circuits for the range 2 and the subsequent ranges are to be turned ON/OFF, irrespective of the adopted method. That is, for the range 2 and the subsequent ranges, switches for turning ON/OFF the corresponding IV conversion circuits are necessary. Therefore, the range 1 corresponds to a first range, and the range 2 and the subsequent ranges correspond to a second range.

According to embodiment 1, it is possible to perform measurement with higher accuracy than in conventional art, for current that is slight and in a high dynamic range. Specifically, the signal processing unit of the nuclear instrumentation device includes: the IV conversion section which includes the IV conversion circuits corresponding to the respective ranges and converts current inputted from the neutron detector to voltage; the amplification section which amplifies the voltage converted by the IV conversion section and outputs the amplified voltage as output voltage; the calculation section which determines the range on the basis of the output voltage, calculates the current value from the output voltage, and outputs the calculated current value as a measurement value; the range switching section which includes the switches corresponding to the respective ranges and switches the range in accordance with a command from the calculation section; and the charge/discharge section which, at the time of switching the range, performs charge/discharge processing of discharging an electric charge stored in the capacitor corresponding to the switching origin range and charging the capacitor corresponding to the switching destination range with the electric charge, Through the charge/discharge processing at the time of range switching, the convergence period of the measurement value at the time of range switching can be shortened, whereby it becomes possible to perform high-accuracy measurement even for current that is slight and in a high dynamic range.

Thus, it becomes possible to perform continuous measurement even for slight current for which measurement by automatic range switching would be infeasible in conventional art, whereby it becomes possible to continuously monitor a nuclear reactor for low to high outputs. In addition, change in the measurement value at the time of range switching is suppressed, whereby erroneous tripping and deviation from safety regulations due to erroneous evaluation of an output distribution of the nuclear reactor can be suppressed. Next, a first modification of embodiment 1 will be

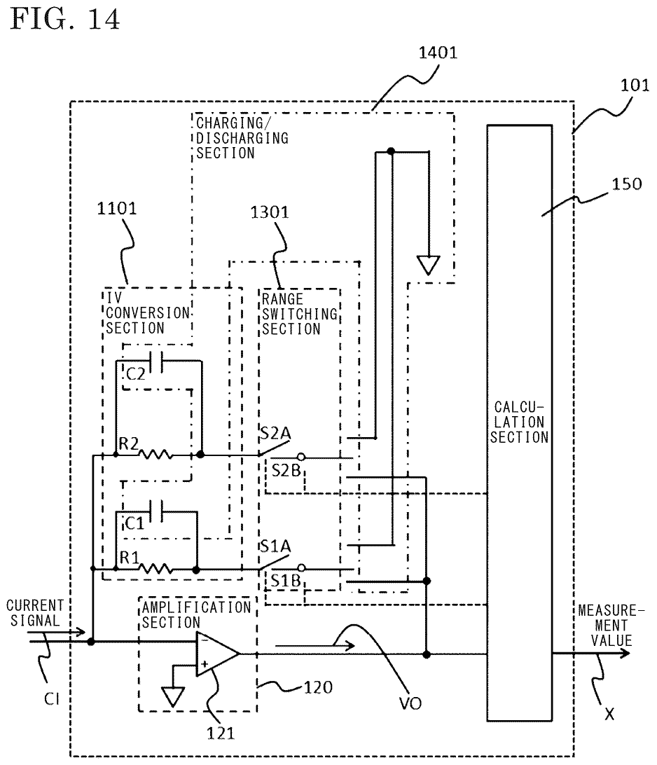

described. FIG. 14 is a configuration diagram showing the first modification of the signal processing unit according to embodiment 1. Also in the first modification, the above Formula (1) is satisfied. Therefore, in a signal processing unit 101, the capacitors for the respective ranges of an IV conversion section 1101 serve also as a part of a charge/discharge section 1401. In FIG. 14, a case where the number of ranges is two is shown, but the same applies to a case where the number of ranges is three or more. In the signal processing unit 101, configurations of the IV conversion section 1101, a range switching section 1301, and the charge/discharge section 1401 are different from those of the IV conversion section 110, the range switching section 130, and the charge/discharge section 140 of the signal processing unit 100.

The IV conversion section 1101 is configured such that the IV conversion circuits respectively corresponding to the range 1 and the range 2 are connected in parallel. The IV conversion circuit for the range 1 is formed by a parallel circuit of the resistor R1 and the capacitor C1. The input side of the parallel circuit is connected to an input terminal (not shown) of the signal processing unit 101 and the inverting terminal of the amplifier 121, and the output side thereof is connected to a switch S1A of the range switching section 1301. The IV conversion circuit for the range 2 is formed by a parallel circuit of the resistor R2 and the capacitor C2. The input side of the parallel circuit is connected to the input terminal (not shown) of the signal processing unit 101, and the output side thereof is connected to a switch S2A of the range switching section 1301.

The range switching section 1301 is configured such that switch sections corresponding to the IV conversion circuits for the respective ranges are connected in parallel. Each switch section is formed by two switches. The switch section corresponding to the range 1 is formed by a switch S1A on the input side and a switch S1B on the output side. The switch section corresponding to the range 2 is formed by a switch S2A on the input side and a switch S2B on the output side. Each of the switches SIA and S2A on the input side is for switching an ON/OFF state between the IV conversion circuit for the corresponding range and the switch S1B, S2B on the output side thereof. Each of the switches S1B and S2B on the output side is for switching the connection destination on the output side of the IV conversion circuit for the corresponding range, between the charge/discharge section 1401 and the output terminal of the amplifier 121. These switches are controlled by the calculation section 150.

The input side of the charge/discharge section 1401 can contact/separate with/from the switches S1B and S2B corresponding to the respective ranges, and the output side thereof is connected to a ground potential.

Range switching in the signal processing unit 101 will be described. Here, a case of switching from the range 1 to the range 2 will be described. In the initial state, the switch SIA is ON, the switch S2A is OFF, and the switch S1B and the switch S2B are connected to the output terminal side of the amplifier 121. At this time, a feedback circuit of the amplifier 121 is formed by the IV conversion circuit for the range 1, so that the IV conversion circuit for the range 1 is turned ON and measurement with the range 1 is performed.

At the time of range switching, the switch S2A is turned ON and the switch S1B is switched to the charge/discharge section 1401 side. Thus, a feedback circuit of the amplifier 121 is formed by the IV conversion circuit for the range 2, so that the IV conversion circuit for the range 2 is turned ON, and the switch S1B is connected to the ground potential of the charge/discharge section 1401, so that a discharge circuit from the capacitor C1 to the capacitor C2 is formed, whereby discharging from the capacitor C1 to the capacitor C2 is performed. That is, charge/discharge processing is performed.

Next, the switch SIA is turned OFF, to turn OFF the IV conversion circuit for the range 1, and the connection destination of the switch S1B is returned to the output terminal side of the amplifier 121. Thereafter, measurement with the range 2 is performed.

As the switch S1B and the switch S2A on the output side, elements such as relays, of which leakage current is small, need to be used. As a result, the switches on the output side of the range switching section 1301 always have a low impedance. Therefore, as the switch SIA and the switch S2B on the input side, semiconductor switches such as analog switches, which can perform high-speed operation though leakage current is great, can be used.

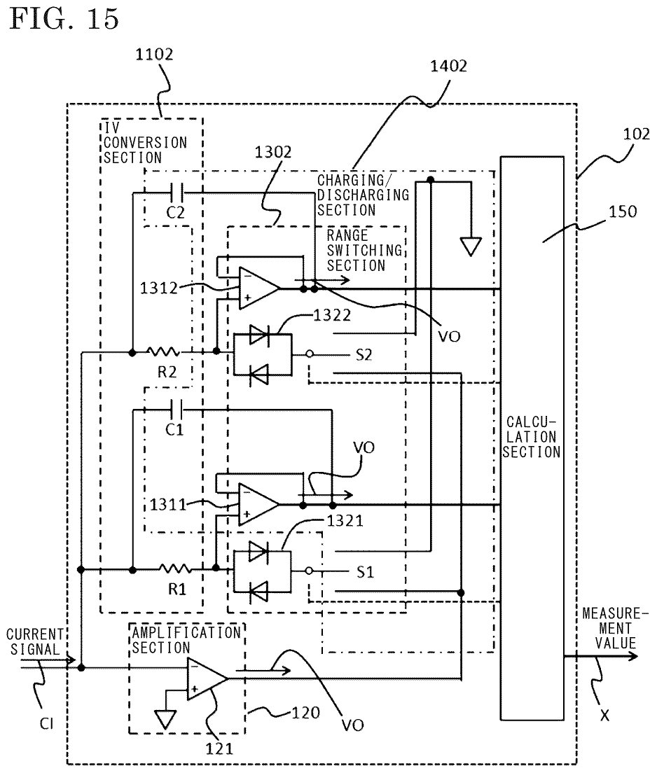

Next, a second modification of embodiment 1 will be described. FIG. 15 is a configuration diagram showing the second modification of the signal processing unit according to embodiment 1. Also in the second modification, the above Formula (1) is satisfied. Therefore, in a signal processing unit 102, the capacitors for the respective ranges of an IV conversion section 1102 serve also as a part of a charge/discharge section 1402. In FIG. 15, a case where the number of ranges is two is shown, but the same applies to a case where the number of ranges is three or more. In the signal processing unit 102, configurations of the IV conversion section 1102, a range switching section 1302, and the charge/discharge section 1402 are different from those of the IV conversion section 110, the range switching section 130, and the charge/discharge section 140 of the signal processing unit 100.

The IV conversion section 1102 is configured such that the IV conversion circuits respectively corresponding to the range 1 and the range 2 are connected in parallel. The IV conversion circuit for the range 1 is formed by a parallel circuit of the resistor R1 and the capacitor C1. A circuit 1321 in which two diodes are connected in antiparallel is connected between the output side of the resistor R1 and the switch S1 of the range switching section 1302. In addition, a voltage follower 1311 is provided between the resistor R1 and the capacitor C1. The voltage follower 1311 has an inverting input terminal and an output terminal connected to each other, and the output terminal is connected to the output side of the capacitor C1 and the calculation section 150. A non-inverting terminal of the voltage follower 1311 is connected between the resistor R1 and the circuit 1321.

The IV conversion circuit for the range 2 is formed by a parallel circuit of the resistor R2 and the capacitor C2. A circuit 1322 in which two diodes are connected in antiparallel is connected between the output side of the resistor R2 and the switch S2 of the range switching section 1302. In addition, a voltage follower 1312 is provided between the resistor R2 and the capacitor C2. The voltage follower 1312 has an inverting input terminal and an output terminal connected to each other, and the output terminal is connected to the output side of the capacitor C2 and the calculation section 150. A non-inverting terminal of the voltage follower 1312 is connected between the resistor R2 and the circuit 1322.

The range switching section 1302 is configured such that switches corresponding to the IV conversion circuits for the respective ranges are connected in parallel. In a switch section corresponding to the range 1, the input side is connected to the circuit 1321, and a connection destination on the output side can be switched between the charge/discharge section 1402 and the output terminal of the amplifier 121. In a switch section corresponding to the range 2, the input side is connected to the circuit 1322, and a connection destination on the output side can be switched between the charge/discharge section 1402 and the output terminal of the amplifier 121. The switch S1 and the switch S2 are controlled by the calculation section 150.

The input side of the charge/discharge section 1402 can contact/separate with/from the switches S1 and S2 corresponding to the respective ranges, and the output side thereof is connected to a ground potential.

Switching of the range in the signal processing unit 102 will be described. Here, a case of switching from the range 1 to the range 2 will be described. In the initial state, the output side of the switch S1 is connected to the output terminal of the amplifier 121, and the output side of the switch S2 is connected to the charge/discharge section 1402. At this time, for the range 1, the diode on the lower side in the circuit 1321 is turned ON and thus a feedback circuit is formed. That is, the IV conversion circuit for the range 1 is ON. On the other hand, the output side of the switch S2 is connected to a ground potential. In this case, the output voltage of the voltage follower 1312 becomes ground voltage, and an electric charge of the capacitor C2 is discharged. As a result, voltages across the two diodes forming the circuit 1322 have the same potential, and a state equivalent to a switch-OFF state is established due to the exponential characteristic of the diodes. That is, the IV conversion circuit for the range 2 is OFF. Thus, the circuit 1321 and the circuit 1322 which are combinations of diodes serve as switches.

At the time of range switching, the connection destination on the output side of the switch S2 is switched to the output terminal of the amplifier 121, and the connection destination on the output side of the switch S1 is switched to the charge/discharge section 1402. Thus, the output side of the switch S1 is connected to the ground potential, whereby discharging from the capacitor C1 is performed. The capacitor C2 is charged with an electric charge discharged from the capacitor C1. Therefore, at this time, the circuit 1322 is turned ON and the circuit 1321 is turned OFF, so that a feedback circuit is formed by the IV conversion circuit for the range 2, and thus the range is switched to the range 2.

The input side of the IV conversion section 1102 is virtually grounded as in embodiment 1. Thus, the potentials on the input sides of the resistors R1 and R2 are also the ground potential, and voltages across the resistors R1 and R2 are respectively equal to output voltages of the voltage followers 1311 and 1312. Therefore, the output voltages of the voltage followers 1311 and 1312 are equal to the output voltage VO, and the current value of the current signal CI can be measured with each range by measuring the output voltages of the voltage followers 1311 and 1312.

In addition, since the output sides of the diodes always have a low impedance, semiconductor switches such as analog switches, which can perform high-speed operation though leakage current is great, can be used as the switches S1 and S2, whereby faster operation can be performed than in a case of using relays.

### Embodiment 2

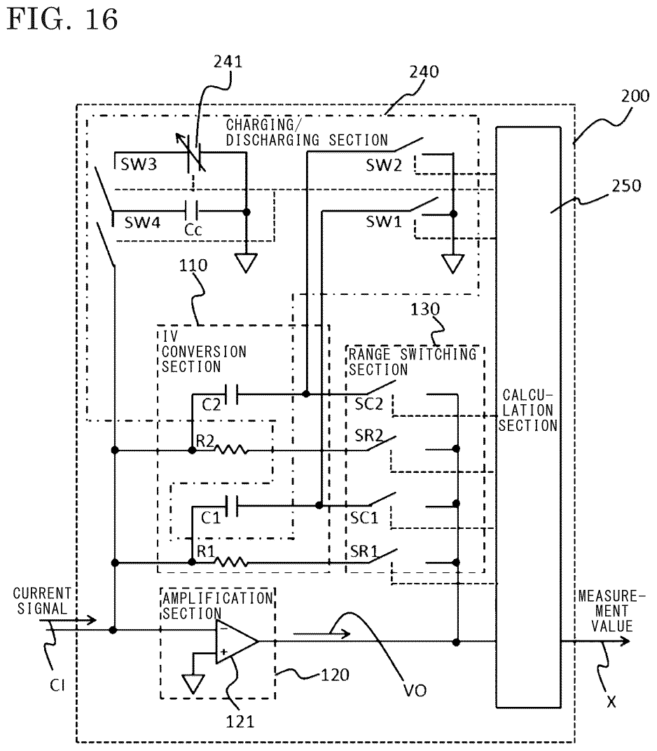

Next, embodiment 2 will be described with reference to FIG. 16 to FIG. 18. Components that are the same as or correspond to those shown in FIG. 1 to FIG. 15 are denoted by the same reference characters, and the description thereof is omitted. In embodiment 2, the entire configuration is the same as that in embodiment 1, but the signal processing unit is different. In addition, in embodiment 2, it is assumed that the constants of the IV conversion circuits are arbitrarily set irrespective of Formula (1) which is supposed to be satisfied in embodiment 1. FIG. 16 is a configuration diagram showing the signal processing unit according to embodiment 2. For simplification of description, only the range 1 and the range 2 are shown in FIG. 16, but the same applies to a case of having the range 3 and subsequent ranges. In a signal processing unit 200, the IV conversion section 110, the amplification section 120, and the range switching section 130 are the same as in the signal processing unit 100 in embodiment 1, but a charge/discharge section 240 and a calculation section 250 are different from those in embodiment 1. For simplification of description, in embodiment 2, a method of turning ON only one IV conversion circuit to realize the measurement range is used.

In a case where the constants (the resistance of the resistor and the capacitance of the capacitor) of the IV conversion circuits for the respective ranges in the IV conversion section 110 are arbitrary values, there is a possibility that, when an electric charge of the capacitor for the switching origin range (range before switching) is all charged into the capacitor for the switching destination range (range after switching) through charge/discharge processing at the time of range switching, charging/discharging is excessive or deficient. The excess or deficiency is compensated through charging/discharging by an electric charge charged in a compensation capacitor Cc (described later) in advance, and this is a feature of embodiment 2. When charging/discharging is deficient, the compensation capacitor Cc serves as a source to provide additional charging. When charging/discharging is excessive, the compensation capacitor Cc serves as a sink to absorb an electric charge remaining in the capacitor for the switching origin range. Hereinafter, the charging amount and the discharging amount are both referred to as a “charging amount”, and whether the compensation capacitor Cc serves as a sink or a source is discriminated using a positive/negative sign of the charging amount.

The charge/discharge section 240 includes switches corresponding to the IV conversion circuits for the respective ranges, as in the charge/discharge section 140, that is, the switch SW1 and the switch SW2 connected in parallel are provided. The input side of the switch SW1 is connected to the output side of the capacitor C1, i.e., between the capacitor C1 and the switch SC1. The input side of the switch SW2 is connected to the output side of the capacitor C2, i.e., between the capacitor C2 and the switch SC2. The output sides of the switch SW1 and the switch SW2 are connected to a ground potential.

The charge/discharge section 240 includes a DC variable power supply 241, and the compensation capacitor Cc connected to the DC variable power supply 241 via the switch SW3. The DC variable power supply 241 and the compensation capacitor Cc have ends (left side in the drawing) connected to an input terminal (not shown) of the signal processing unit 200. Hereinafter, these ends are defined as input sides of the DC variable power supply 241 and the compensation capacitor Cc, and sides opposite to the input sides are referred to as output sides. The output sides of the DC variable power supply 241 and the compensation capacitor Cc are connected to a ground potential. When the switch SW3 is turned ON, the compensation capacitor Cc is charged by the DC variable power supply 241. An electric charge charged in the compensation capacitor Cc is used when the charging/discharging amount is excessive or deficient in charge/discharge processing at the time of range switching, and therefore the compensation capacitor Cc is charged by only a necessary amount. The specific charging amount is determined on the basis of a combination of the switching origin range and the switching destination range.

The input sides of the DC variable power supply 241 and the compensation capacitor Cc are connected to the input side of each IV conversion section via a switch SW4, and when the switch SW4 is turned ON, discharging from the compensation capacitor Cc to the capacitor for the switching destination range in the IV conversion section 110 or discharging from the capacitor for the switching origin range to the compensation capacitor Cc is performed. The DC variable power supply 241, the switch SW3, and the switch SW4 are controlled by the calculation section 250.

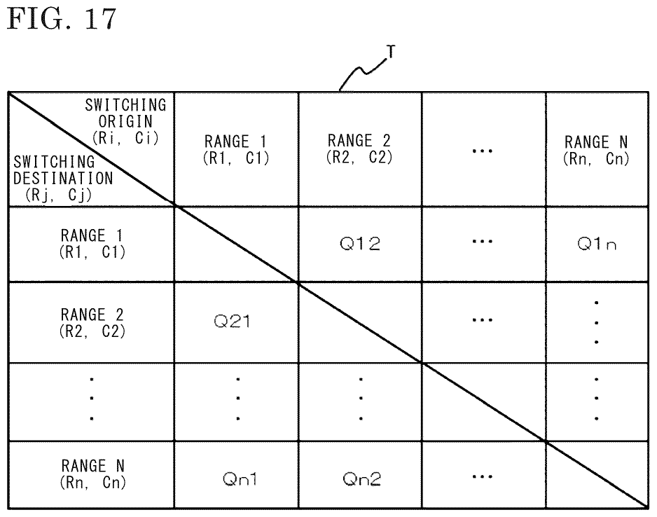

FIG. 17 shows a charge amount table for the compensation capacitor according to embodiment 2. A charge amount table T is a table showing a charging amount Qij by which the compensation capacitor Cc should be charged in association with a case of switching from a range i (i=1, 2, . . . , n) to a range j (j=1, 2, . . . , n). The charge amount table T is stored in a storage section of the calculation section 250, and the calculation section 250 determines a charging amount for the compensation capacitor Cc on the basis of the switching origin range and the switching destination range, and commands the DC variable power supply 241 to charge the compensation capacitor Cc by the determined charging amount. Each charging amount Qij can be calculated in advance from the constants (Ri and Ci) of the IV conversion circuit for the switching origin range and the constants (Rj and Cj) of the IV conversion circuit for the switching destination range, and therefore the charge amount table T is prepared in advance.

In embodiment 2, it suffices that the charging amount deficient for the capacitor for the switching destination range can be compensated, and therefore the charge/discharge section 240 may have any configuration serving as a sink or a source for compensation, without being limited to the compensation capacitor Cc.

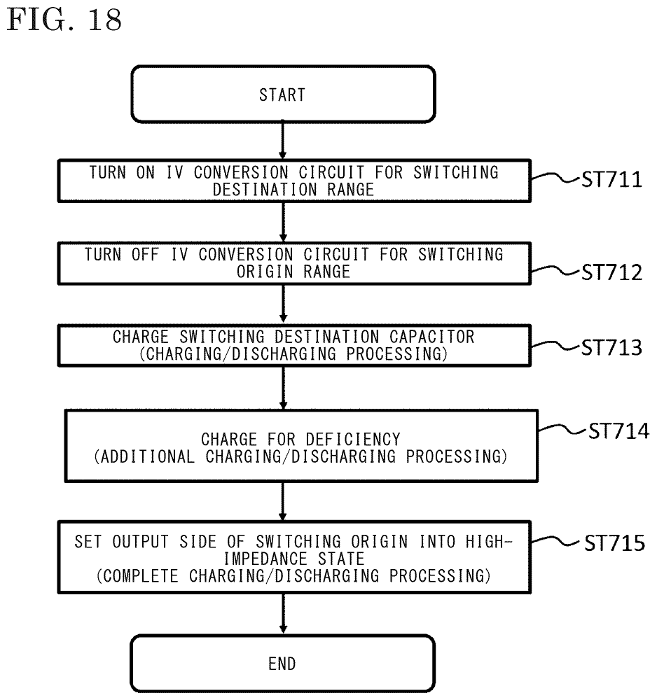

Next, operation will be described. In embodiment 2, the entire operation is the same as in embodiment 1 but a flow of the range switching process is different. FIG. 18 is a flowchart showing the range switching process according to embodiment 2. First, the IV conversion circuit for the switching destination range is turned ON (step ST711).

Next, the IV conversion circuit for the switching origin range is turned OFF (step ST712). As a result, only the IV conversion circuit for the switching destination range is ON.

Next, discharging from the capacitor for the switching origin range to the capacitor for the switching destination range is performed (step ST713, charge/discharge processing). This charge/discharge processing is the same as that in embodiment 1. Thus, the capacitor for the switching destination range is charged.

Next, charging for deficiency or discharging for excess is performed (step ST714). Since a necessary amount of electric charge has been charged in the compensation capacitor Cc, the switch SW3 of the charge/discharge section 240 is turned OFF and the switch SW4 thereof is turned ON, to additionally charge the capacitor for the switching destination range.

Next, the output side of the IV conversion circuit for the switching origin range is set to have a high impedance, thus completing the charge/discharge processing (step ST715), The high-impedance processing is the same as that in embodiment 1.

According to embodiment 2, the same effects as in embodiment 1 can be obtained.

In addition, even in a case where products of the resistances of the resistors and the capacitances of the capacitors in the IV conversion circuits for the respective ranges are not equal to each other, it is possible to prevent excess/deficiency of charging/discharging in charge/discharge processing. Specifically, the charge/discharge section includes a variable DC power supply, and a compensation capacitor to be charged by the variable DC power supply, and after the charge/discharge processing in embodiment 1, the capacitor corresponding to the switching destination range is charged by the compensation capacitor. Thus, when charging for the capacitor for the switching destination range is deficient, additional charging is performed. Therefore, even in a case where products of the resistances and the capacitances in the IV conversion circuits for the respective ranges are not equal to each other, charging for the capacitor for the switching destination range is performed without excess/deficiency. Therefore, it is possible to arbitrarily set the resistances of the resistors and the capacitances of the capacitors in the IV conversion circuits for the respective ranges.

### Embodiment 3

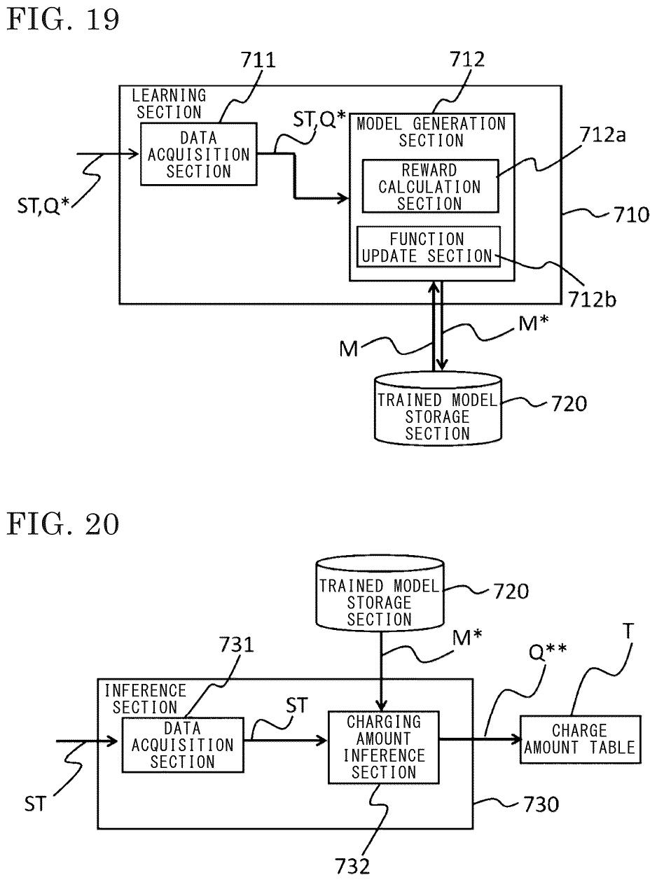

Next, embodiment 3 will be described with reference to FIG. 19 to FIG. 21. Components that are the same as or correspond to those shown in FIG. 1 to FIG. 18 are denoted by the same reference characters, and the description thereof is omitted. In embodiment 3, the charge amount table in embodiment 2 is updated through reinforcement learning. As described above, a necessary charging amount for the compensation capacitor Cc can be calculated in advance from the constants of the IV conversion circuit for the switching origin range and the constants of the IV conversion circuit for the switching destination range. However, due to individual difference among parts and environmental characteristics thereof, there might be a difference between an actual necessary charging amount and a design value. In embodiment 3, in order to enable compensation also for such a difference, the charging amount for the compensation capacitor Cc is optimized through reinforcement learning. For simplification of description, in embodiment 3, the method of turning ON only one IV conversion circuit to realize the measurement range is used.

A case of switching from the range 1 to the range 2 will be described as an example. A necessary charging amount for the compensation capacitor Cc is determined by R1 and C1 which are circuit constants for the switching origin range and R2 and C2 which are circuit constants for the switching destination range, and true values of these circuit constants might be shifted from design values. Here, R1, C1, R2, and C2 are defined as true values, and R1*, C1*, R2*, and C2* are defined as design values. In addition, for the respective circuit constants, deviations are denoted by ΔR1, ΔC1, ΔR2, and ΔC2 (R1*+ΔR1=R1, etc.). In a case of switching from the range 1 to the range 2, if the following Formula (2) is satisfied, the charging amount for the capacitor C2 is deficient, and the measurement value X just after range switching becomes smaller than a true value of the current value which is a measurement target. On the other hand, if Formula (3) is satisfied, the charging amount for the capacitor C2 is excessive, and the measurement value X just after range switching becomes greater than a true value of the current value which is a measurement target.

$$( ( R {2}^{*} + Δ R 2 ) \times ( C {2}^{*} + Δ C 2 ) ) / ( ( R {1}^{*} + Δ R 1 ) \times ( C {1}^{*} + Δ C 1 ) ) > ( R {2}^{*} \times C {2}^{*} ) / ( R {1}^{*} \times C {1}^{*} ) \qquad ( 2 )$$

$$( ( R {2}^{*} + Δ R 2 ) \times ( C {2}^{*} + Δ C 2 ) ) / ( ( R {1}^{*} + Δ R 1 ) \times ( C {1}^{*} + Δ C 1 ) ) < ( R {2}^{*} \times C {2}^{*} ) / ( R {1}^{*} \times C {1}^{*} ) \qquad ( 3 )$$

In a case where Formula (2) is satisfied, the charging amount for the compensation capacitor Cc is increased, and in a case where Formula (3) is satisfied, the charging amount for the compensation capacitor Cc is decreased. Formulae (2) and (3) are such formulae that the magnitudes of the ratio of the time constants of the IV conversion circuit for the switching origin range and the IV conversion circuit for the switching destination range regarding a true value and the ratio of the time constants of the IV conversion circuit for the switching origin range and the IV conversion circuit for the switching destination range regarding a design value are compared with each other.

Update of the charging amount using reinforcement learning is performed through inference by a trained model. Therefore, in embodiment 3, learning by a learning model is also performed. FIG. 19 is a configuration diagram showing a learning section according to embodiment 3. A learning section 710 includes a data acquisition section 711 and a model generation section 712. The learning section 710 may be a component of the calculation section 250, or may be a component of a learning device provided separately.

The data acquisition section 711, i.e., a first data acquisition section, acquires data of a state ST of the nuclear instrumentation device and a charging amount Q* from outside. Specific examples of the state ST include design values of the circuit constants (resistance and capacitance) of the IV conversion circuits for the switching origin range and the switching destination range, the output voltage VO before and after range switching, and temporal transition thereof. In addition, the state of the nuclear instrumentation device may include a temperature and a humidity in the signal processing unit and an operation period of the signal processing unit. By including these, it becomes possible to reflect also the influences of a temperature characteristic, a humidity characteristic, and temporal change. The charging amount Q* is a charging amount (Qij in the charge amount table T) corresponding to a combination of the switching origin range and the switching destination range, and may be acquired from the charge amount table T. The data acquisition section 711 sends the acquired data as training data to the model generation section 712.

The model generation section 712 performs learning on the basis of two inputs (state ST and charging amount Q*), to update the learning model M, and outputs the updated learning model M as a trained model M* to be stored in a trained model storage section 720. The trained model storage section 720 may be a component of the calculation section 250, or may be a component of a storage device provided separately.

In the reinforcement learning, an agent (action entity) in an environment observes the present state (an environmental parameter), and determines an action to take.

The environment dynamically changes in accordance with the action of the agent, and the agent is given a reward in accordance with the change in the environment. The agent repeats this to learn a behavior policy that maximizes a reward obtained throughout a series of actions. As typical methods of reinforcement learning, Q-learning and TD-learning are known. For example, in a case of Q-learning, a general update formula for an action value function Q(s, a) is represented by the following Formula (4).

$$\begin{matrix}[ Mathematical 1 ] & \\ Q ( {s}_{t} , {a}_{t} ) ← Q ( {s}_{t} , {a}_{t} ) + α ( {r}_{t + 1} + γ {max}_{a} Q ( {s}_{t + 1} , a ) - Q ( {s}_{t} , {a}_{t} ) ) & ( 4 )\end{matrix}$$

In Formula (4), st represents the state of the environment at time t and corresponds to a state ST at time t, and at represents an action at time t and corresponds to the charging amount Q* at time t (the charging amount Q* to be used for range switching at this time). Through the action at, the state changes to st+1. In addition, rt+1 represents a reward given as a result of change in the state, γ represents a discount rate, and α represents a learning coefficient. It is noted that γ is in a range of 0<γ≤1 and α is in a range of 0<α≤1. In embodiment 3, the charging amount Q* is the action at, a B2 input (state) is the state ST, and the best action at in the state ST at time t is learned.

According to the update formula represented by Formula (4), if an action value Q for an action a having a highest Q value at time t+1 is greater than the action value Q for an action a taken at time t, the action value Q is increased, and in an opposite case, the action value Q is decreased. In other words, the action value function Q(s, a) is updated so that the action value Q for the action a at time t comes close to the best action value at time t+1. Thus, the best action value in a given environment sequentially propagates to the action value in a previous environment.

As described above, in the case of generating the trained model M* through reinforcement learning, the model generation section 712 includes a reward calculation section 712a and a function update section 712b.

The reward calculation section 712a calculates a reward on the basis of the charging amount Q* and the state ST. The reward calculation section 712a calculates a reward on the basis of a predetermined reward criterion. In embodiment 3, the reward is determined in accordance with change in the current value between before and after range switching. An index for the change may be a standard deviation, for example. As the standard deviation of the current value between before and after range switching becomes smaller, the reward is increased. As a simplest example, a positive reward may be given when the standard deviation is equal to or smaller than a predetermined threshold, and a negative reward may be given when the standard deviation is greater than the threshold.

The function update section 712b updates a function for determining an optimum charging amount for the compensation capacitor Cc with respect to a given combination of a switching origin range and a switching destination range or the like, in accordance with the reward calculated by the reward calculation section 712a, and outputs the updated function to the trained model storage section 720. For example, in a case of Q-learning, the action value function Q (st, at) represented by Formula (4) is used as a function for calculating an optimum charging amount described above.

The trained model storage section 720 stores the action value function Q (st, at) updated by the function update section 712b, i.e., the trained model M*.

FIG. 20 is a configuration diagram showing an inference section according to embodiment 3. An inference section 730 includes a data acquisition section 731 and a charging amount inference section 732.

The data acquisition section 731, i.e., a second data acquisition section, acquires data of the state ST described above. The data acquisition section 731 sends the acquired data to the charging amount inference section 732.

The charging amount inference section 732 infers an optimum charging amount Q** using the trained model M*, That is, when the data of the state ST acquired by the data acquisition section 731 is inputted to the trained model M*, an optimum charging amount Q** for the inputted state ST can be inferred. The charging amount inference section 732 outputs the inferred charging amount Q**, to update the data (data of the charging amount for the corresponding combination of the switching origin range and the switching destination range) in the charge amount table T.

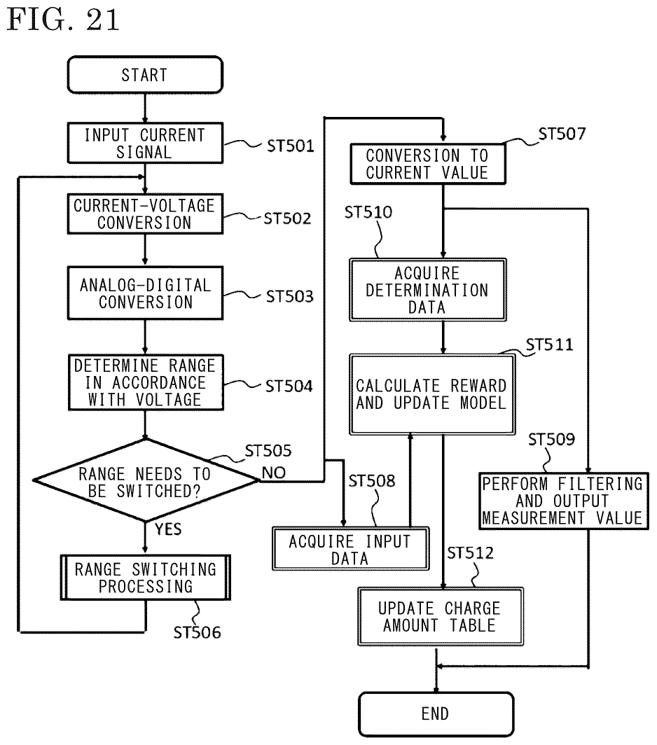

Next, operation will be described. FIG. 21 is a flowchart showing operation of the signal processing unit of the nuclear instrumentation device according to embodiment 3. In embodiment 3, measurement for a current value as in embodiment 1 or 2 and the reinforcement learning are performed in parallel, and therefore processing relevant to the reinforcement learning is shown by a double line. First, the current signal CI from the neutron detector 902a is inputted (step ST501).

Next, as in embodiment 1, the current signal CI is converted to a voltage signal (step ST502), and output voltage VO is subjected to analog-digital conversion (step ST503).

Next, as in embodiment 1, an optimum range is determined (step ST504), and whether or not the range needs to be switched is determined (step ST505). If the range need not be switched, it is determined that the present range has been set at an optimum range. Thereafter, measurement for the current value and processing for the reinforcement learning are performed in parallel. Regarding measurement for the current value, the process proceeds to step ST507. In addition, regarding processing for the reinforcement learning, the process proceeds to step ST508.

If the range needs to be switched, the range switching process is performed (step ST506). After the range is switched, the process returns to step ST502. The details of the range switching process are the same as in embodiment 2.

If it is determined that the present range has been set at an optimum range, as in embodiment 1, a current value is calculated from the output voltage VO (step ST507), a current signal generated as a result of calculation of the current value is filtered, and an obtained measurement value X is outputted (step ST509).

As processing for the reinforcement learning, first, input data is acquired (step ST508), Here, the “input data” refers to the state ST and the charging amount Q* inputted to the data acquisition section 711.

Next, on the basis of the calculation result in step ST507, determination data is acquired (step ST510). Here, the “determination data” is data to be used for reward calculation in the reinforcement learning. As described above, in embodiment 3, a reward is determined in accordance with change in the current value between before and after range switching, and a standard deviation or the like is used as an index for the change, Therefore, a standard deviation of the current value between before and after range switching may be calculated from the calculation result in step ST507.

Next, using the input data acquired in step ST508 and the determination data acquired in step ST510, a reward in the reinforcement learning is calculated. In addition, the learning model M is updated (step ST511). Thus, the trained model M* is obtained.

Next, using the state ST in the input data acquired in step ST508 and the trained model M* acquired in step ST511, an optimum charging amount Q** is inferred, and the charge amount table T is updated on the basis of a result of the inference (step ST512). The updated charge amount table T is used for measurement at the next time and later,

According to embodiment 3, the same effects as in embodiment 2 can be obtained.

In addition, using the method of reinforcement learning, a shift (deviation) between a design value and a true value of a circuit constant is taken into consideration, whereby a more appropriate charging amount for the compensation capacitor can be reflected in the charge amount table.

Although the disclosure is described above in terms of various exemplary embodiments and implementations, it should be understood that the various features, aspects, and functionality described in one or more of the individual embodiments are not limited in their applicability to the particular embodiment with which they are described, but instead can be applied, alone or in various combinations to one or more of the embodiments of the disclosure.

It is therefore understood that numerous modifications which have not been exemplified can be devised without departing from the scope of the present disclosure. For example, at least one of the constituent components may be modified, added, or eliminated. At least one of the constituent components mentioned in at least one of the preferred embodiments may be selected and combined with the constituent components mentioned in another preferred embodiment.

### DESCRIPTION OF THE REFERENCE CHARACTERS

100, 101, 102, 200 signal processing unit
110, 1101, 1102 IV conversion section
120 amplification section
121 amplifier
130, 1301, 1302 range switching section
140, 1401, 1402, 240 charge/discharge section
150, 250 calculation section
241 DC variable power supply
710 learning section
711 data acquisition section
712 model generation section
720 trained model storage section
730 inference section
731 data acquisition section
732 charging amount inference section
902a, 903a, 904a neutron detector
910 nuclear instrumentation device
A1, An IV conversion circuit
C1, C2, Cn capacitor
Cc compensation capacitor
C1 current signal
M learning model
M* trained model
R1, R2, Rn resistor
S1, S1A, S1B, S2, S2A, S2B, SC1, SC2, SCn, SR1, SR2, SRn, SW1, SW2, SW3, SW4 switch
Q*, Q** charging amount
ST state
T charge amount table
VO output voltage
X measurement value

1. A nuclear instrumentation device having a plurality of ranges including a first range and a second range, the nuclear instrumentation device comprising:
a current-voltage conversion circuitry which includes current-voltage conversion circuits which each have a capacitor and a resistor connected in parallel and correspond to the respective ranges, and converts current inputted from a neutron detector to voltage;
an amplification circuitry which amplifies the voltage and outputs the amplified voltage as output voltage;
a range switching circuitry which includes a switch for turning ON/OFF a current-voltage conversion circuit corresponding to the second range, and switches the range by changing the current-voltage conversion circuit to be turned ON or a combination of the current-voltage conversion circuits to be turned ON;
a calculation circuitry which determines the range to be used for measurement for the current, as a measurement range, on the basis of the output voltage, and causes the range switching circuitry to switch the range to the measurement range, and which calculates a current value of the current from the output voltage and outputs an obtained result; and
a charge/discharge circuitry which, at a time of switching the range, performs charge/discharge processing of discharging an electric charge stored in the capacitor corresponding to the range before the switching, and charging the capacitor corresponding to the range after the switching, with the electric charge.

2. The nuclear instrumentation device according to claim 1, wherein
regarding the range before the switching and the range after the switching, products of resistances of the resistors and capacitances of the capacitors for the respective ranges are equal to each other.

3. The nuclear instrumentation device according to claim 1, wherein
the charge/discharge circuitry includes a variable DC power supply, and a compensation capacitor to be charged by the variable DC power supply, and
after the charge/discharge processing, the charge/discharge circuitry discharges the compensation capacitor to further charge the capacitor corresponding to the range after the switching.

4. The nuclear instrumentation device according to claim 3, wherein
the calculation circuitry stores a charging amount for the compensation capacitor in association with a combination of the range before the switching and the range after the switching.

5. The nuclear instrumentation device according to claim 4, further comprising:
a learning circuitry including a first data acquisition circuitry which acquires training data including data of a state of the nuclear instrumentation device including information about the range before the switching and information about the range after the switching, and the charging amount for the compensation capacitor in the state, and a model generation circuitry which generates a trained model for inferring the charging amount for the compensation capacitor from the data of the state, using the training data; and
an inference circuitry including a second data acquisition circuitry which acquires the data of the state, and a charging amount inference circuitry which infers the charging amount for the compensation capacitor on the basis of the data acquired by the second data acquisition circuitry, using the trained model, wherein
the charging amount for the compensation capacitor is updated on the basis of a result of the inference by the charging amount inference circuitry.

6. The nuclear instrumentation device according to claim 1, wherein
the charge/discharge circuitry includes a second switch corresponding to the second range, and
an input side of the second switch is connected to an output side of the capacitor corresponding to the second range, and an output side of the second switch is connected to a ground potential.

7. The nuclear instrumentation device according to claim 1, wherein
an input side of the charge/discharge circuitry is connected to the switch, and an output side of the charge/discharge circuitry is connected to a ground potential,
the switch is for switching a connection destination on an output side of the corresponding current-voltage conversion circuit, between an output side of the amplification circuitry and the input side of the charge/discharge circuitry, and
when the output side of the corresponding current-voltage conversion circuit is connected to the output side of the amplification circuitry, the current-voltage conversion circuit is turned ON, and when the output side of the corresponding current-voltage conversion circuit is connected to the input side of the charge/discharge circuitry, the current-voltage conversion circuit is turned OFF.

8. The nuclear instrumentation device according to claim 7, wherein
a voltage follower which has an output terminal connected to the calculation circuitry and outputs the output voltage to the calculation circuitry is provided between the capacitor and the resistor of the current-voltage conversion circuit, and
an output side of the resistor is connected to a non-inverting input terminal of the voltage follower and connected to an input side of a circuit formed by connecting two diodes in antiparallel, and an output side of the circuit is connected to the switch.

9. The nuclear instrumentation device according to claim 1, wherein
the range switching circuitry further includes a switch for turning ON/OFF the current-voltage conversion circuit corresponding to the first range.
